(19) United States
(12) Patent Application Publication
(10) Pub. No.: US 2007/0220118 A1
(43) Pub. Date: Sep. 20, 2007

(54) Systems, Methods, and Apparatus for Delivering Randomly Accessible Audio and Video Media

(76) Inventor: Douglas E. Loyer, Littleton, MA (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 11/686,800

(22) Filed: Mar. 15, 2007

Related U.S. Application Data
(60) Provisional application No. 60/782,572, filed on Mar. 15, 2006.

(51) Int. Cl. G06F 15/16

(52) U.S. Cl. 709/219

(57) ABSTRACT

The invention includes a method for delivering randomly accessible audio and video media. An application at a client computer requests a media file, and specifies a seek time into the media file, where the seek time is measured from the beginning of the media file. An application at the server computer selects a location in the media file close to the requested seek time, and sends a portion of the media file, starting at the selected location, to the client computer.

### CROSS-REFERENCE TO RELATED APPLICATION

This invention is based upon and claims the benefit of priority from U.S. Provisional Application Ser. No. 60/782,572 filed Mar. 15, 2006, the entire contents of which are incorporated by reference herein.

### FIELD OF THE INVENTION

The invention relates to data communication in a computer network. More particularly the invention relates to improved systems, methods, and apparatus for delivering randomly accessible audio and video media.

### BACKGROUND OF THE INVENTION

Client-server computer networks are well known in the art. An example of a client-server computer network is the computer network commonly known as the Internet. A typical client-server computer network includes one or more client computers connected to one or more server computers. Client computers typically access data or content and application programs from server computers. For example, a web browser running on a client computer may connect to a web server running on a server computer to retrieve and display web pages.

A simplified block diagram of a client computer is generally shown in FIG. 1. Client computer 101 may include, but is not limited to, well know components such as data processor 102; volatile and non-volatile primary memory 103; secondary memory 104 such as hard disks, floppy disks, or other removable media; network interface components 105; display devices and corresponding drivers 106; and audio recording and rendering devices 107. Client computer 101 runs an operating system 108, such as the Microsoft's Windows NT operating system. In addition, client computer 101 may run an Internet browser 109, such as Microsoft's Internet Explorer.

A simplified block diagram of a server computer is generally shown in FIG. 2. Server computer 201 includes well known components similar to those of a client computer, including data processor 202; volatile and non-volatile primary memory 203; secondary memory 204 such as hard disks, floppy disks, or other removable media; network interface components 205; and display devices and corresponding drivers 206. Server computer 201 runs an operating system 207, such as the Microsoft's Windows NT operating system. Server computers may be identified by their DNS (Domain Name Server) hostname, such as the DNS hostname accelacommunications.com.

Client and server computers in a network communicate via protocols. A protocol is a convention or standard that controls or enables the connection, communication, and transfer of data between two computers. Protocols may be implemented in hardware, software, or a combination of the two. The Internet Protocol (IP), the Transmission Control Protocol (TCP), the User Datagram Protocol (UDP), and the Hypertext Transfer Protocol (HTTP) are all well known protocols. Protocols further employ ports, which are used to map communications to specific applications running on the client and server computers.

A simplified block diagram of a client-server computer network is shown in FIG. 3. Network 300 may include one or more client computers 301 and one or more server computers 311 and 312. Server computer 312 may communicate directly with client computer 301. Server computer 311 may communicate with client computer 301 through firewall 321. Firewall 321 may be configured to prevent data from traversing through certain inbound or outbound ports, as determined by the firewall configuration parameters. For example, firewall 321 may be configured to prohibit any data transfer between client computer 301 and server computer 311. Alternatively, firewall 321 may be configured to allow only specific TCP or UDP connections. For example, firewall 321 may be configured to allow outgoing TCP connections to a first set of ports, and outgoing UDP connections to a second set of ports.

Without a firewall, any type of data and/or protocol may be communicated between a client computer and a server computer, provided the appropriate software and/or hardware are used. For example, as shown in FIG. 3, server computer 312 is located on the same side of firewall 321 as client computer 301, such that firewall 321 is not located in the communication path between server computer 312 and client computer 301. Because of this configuration, few, if any, of the ports that client computer 301 may use to communicate with server computer 312 may be blocked.

As shown in FIG. 3, server computer 311 may also communicate with client computer 301 through proxy server 331. A proxy server is a computer that allows indirect connections between a client computer and a server computer around a firewall. Proxy server 331 may allow, for example, HTTP data, which may otherwise be blocked by firewall 321, to be transmitted between server computer 311 and client computer 301.

Many client-server networks, and particularly corporate networks, implement firewalls and proxy servers and impose security rules that place restrictions on the types of network protocols, network ports, MIME types, and data or content that are allowed. Attempts by network administrators to protect their users from computer viruses and other forms of attack have increasingly common, yet unintended consequences. These restrictions may decrease the available bandwidth and increase latency, and in some cases may even prevent these same users from viewing legitimate data or content of interest.

Network security restrictions have a particular impact on the delivery of audio and video content. For example, streaming audio and video media are among the types of content most frequently blocked or degraded by corporate network security efforts. The term “streaming” is used to indicate that the data or content is provided over a network to a client computer on a real-time, as needed basis, rather than being pre-delivered in its entirety before being played back by a media application running on the client computer. The media application renders the streaming data as it received from a server computer over the network, rather than waiting for an entire file to be delivered. While streaming media has its advantages, it is often blocked by firewalls, and may not work well in client-server networks that employ strict security measures.

Browser-accessed rich media, audio, and video applications are often implemented using a tool such as Adobe Flash Player or a media player such as Windows Media Player or Real Media Player. Adobe Flash Player supports several methods for accessing and delivering audio and video content that has been created and stored in the Flash Video (FLV) format, a proprietary file format created by Adobe Systems. These methods include:

(a) Real Time Messaging Protocol (RTMP): The Real Time Messaging Protocol is a proprietary TCP/IP protocol developed by Adobe Systems that allows for streaming audio and video content. RTMP permits fast random seeking of large audio and video files, but this protocol is blocked by many firewalls and proxy servers on corporate networks.

(b) Real Time Messaging Protocol tunneled through HTTP (RTMPT): HTTP Tunneling masks data as HTTP communications in an effort to circumvent firewalls and proxy servers. RTMPT envelops the RTMP protocol in a series of HTTP “POST” requests, such that an attempt to connect using RTMPT will appear as a normal HTTP request. HTTP tunneling, however, does not guarantee success. For example, some proxy servers may be configured to block all access to certain servers, or to examine and then filter content. In addition, RTMPT is more sensitive to network latency, and some proxy servers are not able to sustain a data rate high enough for acceptable playback of a high quality media file. Further, some proxy servers are intentionally configured to limit the rate of network requests from a single client computer to prevent one client computer from monopolizing network resources. This limitation on request rate may have a detrimental effect on audio and/or video playback.

(c) Progressive Download or Progressive Playback: Progressive Playback loads an FLV file directly from a server computer for playback at the client computer. Progressive Download has several advantages, including buffering and use of generic HTTP servers, and works well with most proxy servers and firewalls. While Progressive Playback is more reliable than either RTMP or RTMPT, there may be problems when the media file is more than a few minutes in length. Specifically:

(i) Seeking deeply into a large media file requires the entire media file to be downloaded up to the seek point, which may take a very long time if the media file is large. Progressive Playback does not provide a way to skip or jump to a specific point in a media file without first downloading the entire file up to requested point.

(ii) Media files are kept in the browser cache at the client computer. A subsequent playing of the media file requires the media file to be copied, which may take a long time if the media file is large.

(iii) On a fast network, a media file may download to the user's client computer so quickly that the client computer is unable to play the media file until the download is complete, adding an unacceptable delay to the playback of the media file.

As a result, designers of rich media, video, and audio applications must choose between the flexibility of streaming protocols or the reliability of a progressive playback.

The present invention alleviates or eliminates at least some of the disadvantages of the prior art. These and other advantages of the present invention will be apparent from the description set forth below.

### SUMMARY OF THE INVENTION

The present invention provides improved methods and apparatus for delivering randomly accessible audio and video media. An application at a client computer requests a media file, and specifies a seek time into the media file, where the seek time is measured from the beginning of the media file. An application at the server computer selects a location in the media file closest to the requested seek time, and sends a portion of the media file, starting at the selected location, to the client computer.

### BRIEF DESCRIPTION OF THE DRAWINGS

Other objects, features and advantages will occur to those skilled in the art from the following description of the preferred embodiments and the accompanying drawings, in which:

FIG. 1 is a simplified block diagram of a prior art client computer;

FIG. 2 is a simplified block diagram of a prior art server computer;

FIG. 3 is a simplified block diagram of a prior art client-server computer network; and

FIG. 4 is a simplified flowchart of a preferred embodiment of the inventive method for delivering randomly accessible audio and video media.

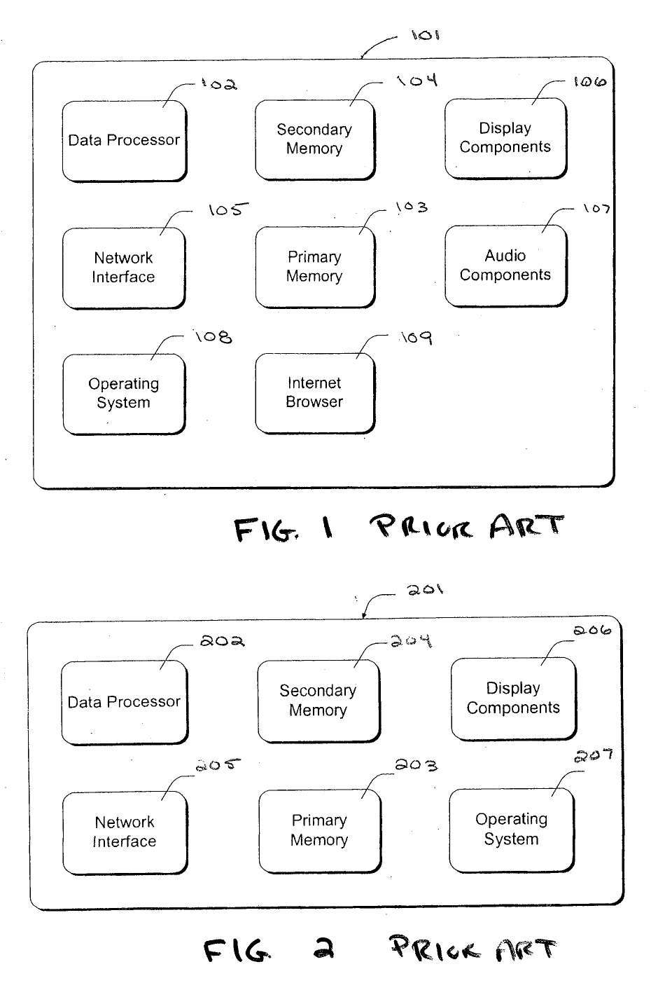

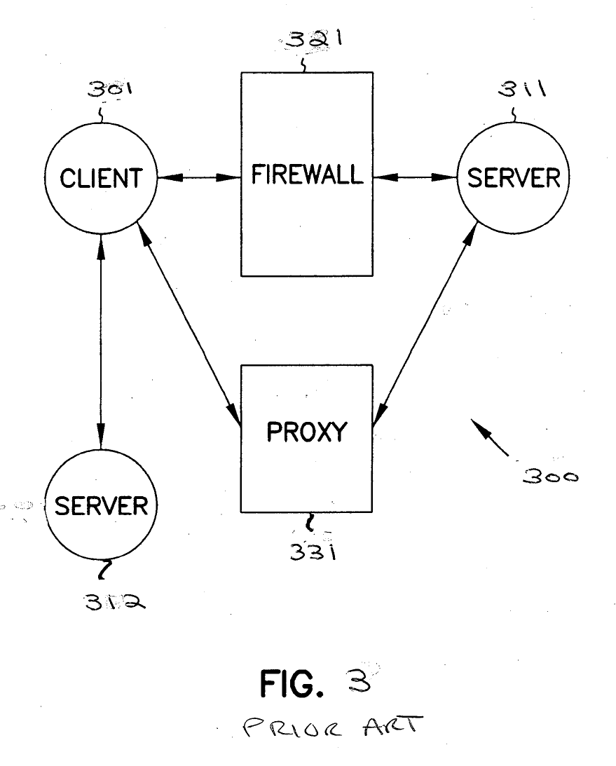

### DETAILED DESCRIPTION OF THE PREFERRED EMBODIMENTS

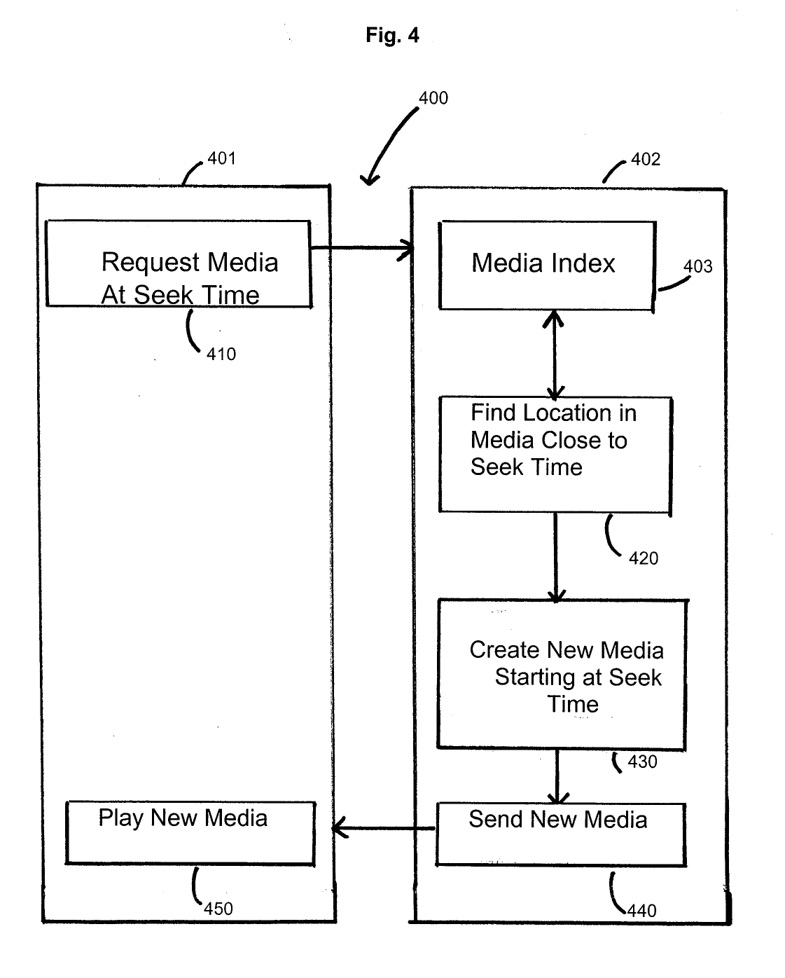

The present invention relates to methods and apparatus for delivering randomly accessible audio and video media. A simplified flowchart of a preferred embodiment of the inventive method for delivering randomly accessible audio and video media 400 is generally shown in FIG. 4. At step 410, a user at client computer 401 requests audio or video media or content from a server computer 402. The requested audio or video media may be in the form of an FLV file. FLV files, like other media files, contain header information and a number of frames. An FLV file may contain several types of frames, including:

(i) Video keyframes: A video keyframe encodes one still video frame. Keyframes normally require more bytes and are encoded less frequently than other types of frames. Audio FLV files do not contain video keyframes.

(ii) Incremental video frames: An incremental video frame encodes incremental changes to the previous video keyframe, and requires fewer bytes than a video keyframe. A video keyframe must be encoded before any incremental video frames are encoded. Audio FLV files do not contain incremental video frames.

(iii) Audio frames: Audio frames encode a small section of the audio track associated with the video file, and are regularly spaced. Video FLV files typically, but not always, include audio frames.

Each video keyframe, incremental video frame, and audio frame contains a time offset, which is measured from the start of the FLV file.

With further reference to FIG. 4, the media request sent by the client computer at step 410 includes a seek time into the audio or video media. The seek time is the user-specified time to begin playback of the audio or video media. For example, a seek time of zero means start playback at the beginning of the audio or video media, and a seek time of 1000 milliseconds (ms) means start playback 1000 ms after the start of the audio or video media. If no seek time is specified in the media request, a default seek time of zero is used. The media request is sent to the server computer in the form of an HTTP GET request. To any proxy servers or firewalls between the client computer and the server computer the request appears to be normal web browsing or simple retrieval of a static media file. Further, since only a single HTTP request is used, even those proxy servers that are too slow to support HTTP Tunnel protocols are likely to sustain enough bandwidth for the media request. In addition, sending only a single request may overcome the request rate limitation imposed by some proxy servers.

At step 420 the server computer receives the HTTP GET request and uses a media index 403, stored at the server computer, to find the location in the audio or video media that is close to the requested seek time, such that playback will start at a point near the requested seek time. If the requested video media is a video FLV file, the media index is an index of keyframe locations, and the server computer uses the media index to find the location in the FLV file of a keyframe that is close to the requested seek time, which may be before or after the requested seek time. If the requested media is an audio FLV file, the media index contains the location of the regularly spaced audio frames.

At step 430 the server computer creates a new media file, where the new media file starts at the requested seek time, and at step 440 the server computer sends the new media file to the client computer as the response to the HTTP request. For example, if the requested seek time is 1000 ms, the new media file will contain only that portion of the requested media that begins at approximately 1000 ms and follows thereafter. Sending only a portion of the media avoids a potentially long playback delay while unwanted media is downloaded to the client computer. At step 450, the client computer begins playing the new media file.

In a preferred embodiment, the server computer begins sending the new media file immediately, as it is created, rather than waiting until the entire new media file is complete. This eliminates the need to store the new media file on the server computer. To the media player at the client computer, the new media file appears to be a simple static file located on a normal web server.

If the requested media is an audio FLV file, the server computer creates a new audio FLV file, starting with the first audio frame after the requested seek time and adjusting the time offset in each audio frame to be relative from the requested seek time.

For example, if the requested seek time is 3000 milliseconds, the server computer locates, using the index, the first indexed audio frame with a time offset less than or equal to 3000 milliseconds. The server computer then reads the FLV file and discards all audio frames until it finds an audio frame with a time offset greater than or equal to 3000 milliseconds. The server computer than adjusts the time offset of this frame, and all subsequent frames, by subtracting 3000 milliseconds, to dynamically generate a new FLV file that appears to start at approximately 3000 milliseconds.

If the requested media is a video FLV file, there are a number of different ways in which the server computer may deliver the requested content to the user, including, but not limited to, the following:

(i) The server computer may create a new video keyframe with a time offset approximately equal to the requested seek time by combining: (1) the last video keyframe with a time offset less than or equal to the requested seek time; and (2) all subsequent incremental video and audio frames that have a time offset less than or equal to the requested seek time.

For example, if the requested seek time is 5100 milliseconds, and the index includes a first video keyframe X having a time offset of 4500 milliseconds, and a second video keyframe X+1 having a time offset of 5500 milliseconds, the server computer will create a new video keyframe by combining the first video keyframe X with all the subsequent incremental video frames up to 5100 milliseconds. This new video keyframe becomes the first video keyframe in the new FLV file, followed by the remaining incremental video and audio frames, followed by video keyframe X+1, and so on.

This method may be difficult to implement, as it requires significant data processing and an understanding of the associated codec (the device or program that encodes and decodes the digital data stream). In addition, each different codec may require different data processing.

(ii) The server computer may use a method similar to that used for audio FLV files by creating a new FLV file starting with the first incremental video frame that has a time offset greater than or equal to the requested seek time.

Continuing with the previous example, the new FLV file will not contain video keyframe X, but will include all the incremental video and audio frames starting at approximately 5100 milliseconds, followed by video keyframe X+1 and all subsequent audio and video frames with times offset by the requested seek time. This method may not be acceptable from the user's point of view because the video may appear distorted for some period, at least until video keyframe X+1 is played.

(iii) The server computer may create a new FLV file starting with the last video keyframe that has a time offset less than or equal to the requested seek time, marking this video keyframe as time zero, then adding only those incremental video and audio frames between this video keyframe and the next video keyframe that have a time offset equal to or greater than the requested seek time, followed by all frames starting with the next keyframe with times offset by the requested seek time.

Continuing with the previous example, the new FLV file will include video keyframe X; will not include the incremental video and audio frames between video keyframes X and X+1 with time offsets between 4500 milliseconds and 5100 milliseconds, resulting in a gap; and will include the incremental video and audio frames between video keyframes X and X+1 with time offsets greater than or equal to 5100 milliseconds. This method may not be acceptable from the user's point of view because the missing incremental video frames may cause the playback to be distorted.

(iv) The server computer may create a new FLV file starting with the last video keyframe that has a time offset less than or equal to the requested seek time, marking this video keyframe as time zero, then adding all the incremental video frames between this video keyframe and the requested seek time, and marking these incremental video frames as time zero, followed by all frames at times greater than or equal to the requested seek time with times offset by the requested seek time.

Continuing with the previous example, the new FLV file will include video keyframe X; will include the incremental video frames between keyframe X and the requested seek time with time offsets between 4500 milliseconds and 5100 milliseconds, all marked as time zero; and will include all incremental video and audio frames with time offsets greater than or equal to 5100 milliseconds, with their time offsets adjusted relative to the requested seek time of 5100 milliseconds.

This is similar to the previous approach, except that here all the incremental video frames between the two video keyframes are included in the new FLV file. While this method may result in a better quality video, the results may still not be acceptable from the user's point of view because the video will appear to fast forward as each incremental video frame is played, and the video will be jerky.

(v) The server computer may create a new FLV file starting with the last video keyframe that has a time offset less than or equal to the requested seek time, marking this video keyframe as time zero, not include any of the incremental video frames until the next keyframe is reached, but include all of the audio frames with a time offset greater than or equal to the requested seek time and all of the video frames starting with the next keyframe. From the user's point of view, the video in the first video keyframe will display, then the audio will play while the video freezes because of the missing incremental video frames. The video will resume playing when the next video keyframe is rendered.
(vi) In a preferred embodiment, the server computer locates, in the index, the first video keyframe having a time offset greater than or equal to the requested seek time and creates a new FLV file starting with this video keyframe marked as time zero. Then, starting at the previous video keyframe, the server computer will add all the audio frames with a time offset greater than or equal to the requested seek time, but will not include the previous video keyframe or any of the incremental video frames or repeat the first video keyframe at or after the requested seek time. All frames after the first video keyframe after the requested seek time are included with times offset by the requested seek time.

For example, a user may request a starting point in the video file of 5100 milliseconds. The video file may have two video keyframes in the index: a first video keyframe X at 4500 milliseconds and a second video keyframe X+1 at 5500 milliseconds. The server computer will locate video keyframe X+1. The new FLV file will start with video keyframe X+1 marked as time zero, and include all the audio frames with time offsets greater than or equal to 5100 milliseconds. The new FLV file will not include video keyframe X or repeat the video keyframe X+1, or any incremental video frames between video keyframe X and X+1. This approach is similar to the previous approach, but will display the video keyframe X+1 rather than X. This approach provides smoother video playback.

As a result, the user will see the video from video keyframe X+1, the video will then freeze while the audio plays starting at time 5100 milliseconds, and the video will resume at 5500 milliseconds.

(vii) In a preferred embodiment, the server computer locates, in the index, the last video keyframe having a time offset less than the requested seek time. The server computer will create a new FLV file without including this keyframe but include all audio frames having a time offset greater than or equal to the requested seek time, but not include the incremental video frames until the next video keyframe is reached, then include all audio and video frames with times that are offset by the requested seek time.

Continuing with the previous example, the new FLV file will not include video keyframe X, but include all audio frames having a time offset greater than or equal to 5100 milliseconds, and video keyframe X+1 and all subsequent frames. As a result, the user will hear audio, but see no new video for 400 milliseconds until the next keyframe is reached. Any previously displayed video will remain until the next keyframe is reached. When the user seeks, the video will appear to freeze for a short time, but audio will play.

The server computer also includes one or more HTTP headers in the response to the client computer to prevent new media from being cached at the client computer or in a proxy server. The HTTP headers may include either of the following fields:

(a) Cache-Control: The Cache-Control general-header field is used to specify directives that must be obeyed by all caching mechanisms along the request/response chain. To prevent caching, the value should be set to “no-cache” and “no-store.”

(b) Pragma: The Pragma general-header field is used to include implementation-specific directives that might apply to any recipient along the request/response chain. To prevent caching, the value should be set to “no-cache.”

In a preferred embodiment, the server computer is not required to decide which headers are needed for a specific client, and sends both headers.

With further reference to FIG. 4, if, at step 420 the media index does not exist, the server computer will create a media index. Since the server computer has the media stored locally on the server computer, it is able to scan the media file and create a media index much more quickly than the media could be downloaded to the client computer.

The server computer monitors the rate at which it sends media to the client computer. The server computer places an upper limit on how fast a single client computer may download media. This upper limit is preferably greater than real time, up to a limit of twice real time, but other values, including no limit, are within the scope of the invention. In a preferred embodiment, the upper limit may be configured by the network administrator.

The server computer also places an upper limit on how far ahead of real time the user may download. This upper limit is preferably greater than the maximum buffer size at the client computer. In a preferred embodiment, the upper limit is configurable by the network administrator. By setting limits, the server computer is attempting to prevent any one user at a client computer from using too much bandwidth, and also reduce the amount of potentially wasted bytes of media if the user seeks to a different place in the media. In addition, setting limits may prevent problems with slower client computers that are on a fast data connection, that may not be able to download and render video media at the same time.

The inventive methods described above may be implemented either in software or hardware, such as via an IC (integrated circuit) chip. The invention may also be embodied as computer readable code on a computer readable medium. The computer readable medium is any data storage device that can store data and that can later be read by a computer system. Examples of computer readable medium include, but are not limited to, random access memory, read only memory, CD-ROMs, optical data storage devices, and magnetic tape. The computer readable code may also be distributed over a network.

Although specific features of the invention are shown in some figures and not others, this is for convenience only, as some features may be combined with any or all of the other features in accordance with the invention.

The use of any and all examples, or exemplary language (e.g., “such as”) provided herein, is intended merely to better illustrate the invention and does not pose a limitation on the scope of the invention.

A variety of modifications to the embodiments described herein will be apparent to those skilled in the art from the disclosure provided herein. Thus, the invention may be embodied in other specific forms without departing from the spirit or essential attributes thereof.

What is claimed is:

1. A method for delivering at least a portion of a media file to a client computer from a server computer, the method comprising:
receiving, from the client computer, a request for the media file, the request including a seek time into the media file;
selecting a location in the media file close to the requested seek time; and
sending, to the client computer, at least a portion of the media file starting at the selected location.

2. The method of claim 1, where the seek time is measured from a beginning of the media file.

3. The method of claim 1, where the media file contains audio data.

4. The method of claim 1, where the media file contains audio data and video data.

5. The method of claim 1, where the media file includes a plurality of sequenced frames and each frame has a starting time measured from the beginning of the media file; the selecting step comprises selecting an initial frame in the media file, where the initial frame is the frame having a starting time closest to the requested seek time; and the sending step comprises sending, to the client computer, the initial frame and at least a subset of the one or more frames that follow the initial frame in the sequence.

6. The method of claim 5, where the initial frame is selected by searching an index file, where the index file contains a location for each frame.

7. The method of claim 6, further comprising creating the index file if the index file does not exist.

8. The method of claim 1, where the media file includes a plurality of sequenced audio frames, and each audio frame has a starting time measured from the beginning of the media file; the selecting step comprises selecting an initial audio frame with a starting time less than or equal to the requested seek time; and the sending step comprises sending, to the client computer, the initial audio frame and at least a subset of the one or more audio frames that follow the initial audio frame in the sequence.

9. The method of claim 1, where the media file includes a plurality of sequenced video keyframes and each video keyframe has a starting time measured from the beginning of the media file; the selecting step comprises selecting an initial video keyframe with a starting time less than or equal to the requested seek time; and the sending step comprises sending, to the client computer, the initial video keyframe and at least a subset of the one or more video keyframes that follow the initial video keyframe in the sequence.

10. The method of claim 1, where the media file includes a plurality of sequenced video keyframes and a plurality of sequenced audio frames, and each video keyframe and each audio frame has a starting time measured from the beginning of the media file; the selecting step comprises selecting an initial video keyframe with a starting time greater than the requested seek time; and the sending step comprises sending, to the client computer, the initial video keyframe and at least a subset of the one or more audio frames with a starting time greater than or equal to the requested seek time.

11. A computer-readable medium containing computer-readable instructions for delivering at least a portion of a media file to a client computer from a server computer, the computer-readable instructions comprising:
computer-readable instructions for receiving, from the client computer, a request for the media file, the request including a seek time into the media file;
computer-readable instructions for selecting a location in the media file close to the requested seek time; and
computer-readable instructions for sending, to the client computer, at least a portion of the media file starting at the selected location.

12. The computer-readable instructions of claim 11, where the seek time is measured from a beginning of the media file.

13. The computer-readable instructions of claim 11 where the media file includes a plurality of sequenced frames and each frame has a starting time measured from the beginning of the media file; the computer-readable instructions for selecting comprise selecting an initial frame in the media file, where the initial frame is the frame having a starting time closest to the requested seek time; and the computer-readable instructions for sending comprise sending, to the client computer, the initial frame and at least a subset of the one or more keyframes that follow the initial frame in the sequence.

14. The computer-readable instructions of claim 13, where the computer-readable instructions for sending further comprise selecting the initial frame by searching an index file, where the index file contains a location for each frame.

15. The computer-readable instructions of claim 13, further comprising computer-readable instructions for creating the index file if the index file does not exist.

16. The computer-readable instructions of claim 11, where the media file includes a plurality of sequenced audio frames, and each audio frame has a starting time measured from the beginning of the media file; the computer-readable instructions for selecting comprise selecting an initial audio frame with a starting time less than or equal to the requested seek time; and the computer-readable instructions for sending comprise sending, to the client computer, the initial audio frame and at least a subset of the one or more audio frames that follow the initial audio frame in the sequence.

17. The computer-readable instructions of claim 11, where the media file includes a plurality of sequenced video keyframes and each video keyframe has a starting time measured from the beginning of the media file; the computer-readable instructions for selecting comprise selecting an initial video keyframe with a starting time less than or equal to the requested seek time; and the computer-readable instructions for sending comprise sending, to the client computer, the initial video keyframe and at least a subset of the one or more video keyframes that follow the initial video keyframe in the sequence.

18. The computer-readable instructions of claim 11, where the media file includes a plurality of sequenced video keyframes and a plurality of sequenced audio frames, and each video keyframe and each audio frame has a starting time measured from the beginning of the media file; the computer-readable instructions for selecting comprise selecting an initial video keyframe with a starting time greater than the requested seek time; and the computer-readable instructions for sending comprise sending, to the client computer, the initial video keyframe and at least a subset of the one or more audio frames with a starting time greater than or equal to the requested seek time.

19. A system comprising:
a client computer having computer-executable instructions for
requesting a media file, where the request includes a seek time into the media file; and
a server computer having computer-executable instructions for
receiving the request for a media file from the client computer,
selecting a location in the media file close to the requested seek time, and
sending at least a portion of the media file starting at the selected location.

20. The system of claim 19, where the client computer further includes computer-executable instructions for rendering the at least a portion of the media file.

21. The system of claim 19, where the media file includes a plurality of sequenced frames and each frame has a starting time measured from the beginning of the media file; and
the server computer further includes computer-executable instructions for selecting an initial frame in the media file, where the initial frame is the frame having a starting time closest to the requested seek time, and computer-executable instructions for sending, to the client computer, the initial frame and at least a subset of the one or more keyframes that follow the initial frame in the sequence.

22. The system of claim 21, where the server computer further includes computer-executable instructions for selecting an initial frame by searching an index file, where the index file contains a location for each frame.

23. The system of claim 22, where the server computer further includes computer-executable instructions for creating the index file if the index file does not exist.

24. The system of claim 19, where the media file includes a plurality of sequenced audio frames, and each audio frame has a starting time measured from the beginning of the media file; and
the server computer further includes computer-executable instructions for selecting an initial audio frame with a starting time less than or equal to the requested seek time, and computer-executable instructions for sending, to the client computer, the initial audio frame and at least a subset of the one or more audio frames that follow the initial audio frame in the sequence.

25. The system of claim 19, where the media file includes a plurality of sequenced video keyframes and each video keyframe has a starting time measured from the beginning of the media file; and
the server computer further includes computer-executable instructions for selecting an initial video keyframe with a starting time less than or equal to the requested seek time, and computer-executable instructions for sending, to the client computer, the initial video keyframe and at least a subset of the one or more video keyframes that follow the initial video keyframe in the sequence.

26. The system of claim 19, where the media file includes a plurality of sequenced video keyframes and a plurality of sequenced audio frames, and each video keyframe and each audio frame has a starting time measured from the beginning of the media file; and
the server computer further includes computer-executable instructions for selecting an initial video keyframe with a starting time greater than the requested seek time, and computer-executable instructions for sending, to the client computer, the initial video keyframe and at least a subset of the one or more audio frames with a starting time greater than or equal to the requested seek time.
